(19) United States
(12) Patent Application Publication
(10) Pub. No.: US 2002/0012352 A1
(43) Pub. Date: Jan. 31, 2002

(54) Internet protocol handler for telecommunications platform with processor cluster

(76) Inventors: Goran Hansson, Arsta (SE); Bengt Engman, Haninge (SE); Lars Marklund, Stockholm (SE)

Correspondence Address: NIXON & VANDERHYE P.C., 8th Floor, 1100 North Glebe Road, Arlington, VA, 22201, US

(21) Appl. No.: 09/900,471

(22) Filed: Jul. 9, 2001

Related U.S. Application Data
(63) Continuation-in-part of application No. 09/467,018, filed on Dec. 20, 1999.

(30) Foreign Application Priority Data
Dec. 18, 1998 (WO) PCT/IB98/02080

(51) Int. Cl. H04L 12/28

(52) U.S. Cl. 370/401; 370/469

(57) ABSTRACT

A telecommunications platform (20) has a cluster (32) of processors (30) which collectively perform a platform processing function. Plural processors of the cluster have Internet Protocol (IP) capabilities and respective plural IP interfaces (34). An Internet Protocol (IP) handler (60) distributed throughout the cluster facilitates applications executing on the plural processors comprising the cluster to be addressed using a same media access layer (MAC) address. That is, the Internet Protocol (IP) handler comprises a single IP stack (62) which is addressed with the same media access layer (MAC) address. The Internet Protocol (IP) handler comprises a media access control (MAC) bridge (70). The MAC bridge in turn comprises a first bridge port (72_{A}) connected by an ethernet link interface (64) to the IP stack; a second MAC bridge port (72_{B}) provided by a first processor (30₁) of the cluster; a third MAC bridge port (72_{C}) provided by a second processor (30ₙ) of the cluster; and, a MAC bridge communications system (74) connecting the virtual bridge port, the virtual bridge port, and the third bridge port to each other. Each of the second bridge port and the third bridge port have a MAC/port table (80) by which the ports can associate the MAC address of the IP stack with the virtual bridge port, thereby permitting the IP stack to be addressable with one and the same media access layer (MAC) address. In one embodiment, the platform can connect to plural local area networks (78₁ and 78₂). In an alternate embodiment, the cluster is connected to a sole local area networks (78).

This application is a continuation-in-part application of U.S. patent application Ser. No. 09/467,018 filed Dec. 20, 2000, entitled “Internet Protocol Handler For Telecommunications Platform With Processor Cluster”, which is incorporated herein by reference. In addition, this application claims the benefit and priority of International Patent Application PCT/IB98/02080 filed Dec. 18, 1998, entitled “Telecommunication 15”, which is incorporated herein by reference.

### BACKGROUND

1. Field of the Invention

The present invention pertains to platforms of a telecommunications system, and particularly to such platforms having a multi-processor configuration and Internet Protocol (IP) capabilities.

2. Related Art and Other Considerations

An Internet Protocol (IP) network comprises Internet Protocol (IP) routers, links that transport Internet Protocol (IP) packets between routers, and. An Internet Protocol (IP) router forwards Internet Protocol (IP) packets received at incoming links to suitable outgoing links for onward transportation through the network. The outgoing links are selected by looking at a destination IP address in the IP packets and comparing them with information in a routing table. The routing table contains information about a next hop (router) address to which to send the packets, and also information about which outgoing link to use to reach that next hop address. An Internet Protocol (IP) host is a device that contains Internet Protocol (IP) functionality to generate or receive IP packets, but no IP forwarding functionality. Often a device contains both host and router functionality. A link is attached to a host and/or a router via a link interface. A link interface has an assigned IP address.

When a host is connected to an Internet Protocol (IP) network via a link attached to a link interface, the Internet Protocol (IP) address of the link interface is used as a destination IP address for the host. If more than one link is connected to a host, any of the IP addresses of the link interfaces may be used to address the host. The IP address of a link interface that is connected to a router may also be a next-hop address if the link is connected to another router.

Various types of transport services can be provided to a software application that uses an IP network for communication. Such transport services include the Transmission Control Protocol (TCP) transport service; the User Datagram Protocol (UDP) transport service; and the raw IP transport service (e.g., direct access to the Internet Protocol (IP) transport function). The TCP and UPD transport services provide additional functionality on top of the IP network transport function. TCP provides a connection-oriented service with reliable transport of data. That is, data is protected from loss, reordering, misinsertion, etc. UDP is a relatively non-reliable datagram service. Both TCP and UDP transport services operate end-to-end on a data flow. That is, TCP and UDP functions are not involved in intermediate nodes in the IP network, only the nodes where the data flow originates and terminates.

Typically, TCP, UDP, and raw IP transport services are provided to a user application via a socket interface. A “port” concept makes it possible for several applications to use TCP or UDP transport simultaneously via the same source IP address. Applications are separated from each other by using different TCP or UDP port numbers. Different user applications may use the same TCP or UDP port number if they use different IP source addresses, but if the same IP source address is used, different port numbers must be used. Some port numbers are reserved for specific, well-known applications.

A TCP segment or UDP datagram contains information about source and destination port numbers. A TCP segment or UDP datagram is sent in an IP packet. The IP packet contains information about the source and destination IP addresses.

When a user application initiates TCP or UDP communication, the user application creates a socket interface with the desired port number, and binds it to an IP source address. If TCP transport is used, a connection is established toward a destination socket specified by a destination port number and a destination IP address. If UDP is used, no connection is established. Instead, the destination socket is specified for every UDP datagram that is sent by submitting the destination port and the destination IP address. The raw IP transport service provides no additional functionality on top of the IP layer. The raw IP transport service basically provides a socket interface towards the IP layer transport function. Port numbers can not be used to separate different users when using the raw IP transport service. Instead, the protocol number in the IP header specifying the user protocol is used to separate different users. The protocol number is specified by a software application when it binds to a raw IP socket.

Functionality is generally provided for transporting IP packets over an ethernet Local Area Network (LAN). To the IP host and router function entity, the IP over ethernet link appears as a generic link. The ethernet dependent functionality is hidden from the IP host and router function. This includes an Address Resolution Protocol (ARP) that is used to translate IP addresses to ethernet Media Access Control (MAC) addresses.

When an IP over ethernet link needs to find out the Ethernet MAC address to a link interface attached to a host or router on an Ethernet LAN that has a specific IP address assigned to it, the IP over ethernet link function broadcasts an ARP Request message on the Ethernet LAN. The ARP request message contains the IP address whose MAC address is requested and also the MAC address of the link that sent out the ARP request, so that the response can be sent to the correct link interface. The IP over ethernet link interface that has the requested IP address will then respond with an ARP response message containing the requested MAC address. The IP over ethernet link entity that sent out the request then stores the MAC address of the IP address and uses it when data is to be sent to the concerned IP address. The ARP protocol is a standard function.

There also may be functionality in an IP network for transporting IP packets over an Asynchronous Transport Mode (ATM) network. The ATM dependent functionality is hidden from the IP host and router function. To transport IP packets over ATM, the ATM Adaptation Layer 5 (AAL5) is often used. The ATM dependent functionality includes, for example, functionality for encapsulating IP packets into AAL5 Service Data Units (SDUs). Encapsulation of IP packets into AAL5 SDUs is specified in the Internet Engineering Task Force (IETF) Request For Comment (RFC) number 1483. The ATM dependent functionality also includes functionality for translating IP addresses to ATM addresses.

In prior art multi-processor systems having internet capabilities, typically each processor involved with internet transmissions has a distinct internet protocol address which is closely tied to the hardware and Ethernet interface of the processor. The processors collectively form a local area network (LAN). Internet protocol (IP) traffic is routed to and from these processors either by a dedicated router connected to the same LAN or by one of the processors of the LAN running special router software.

It has become desirable in at least some multi-processor environments to view the processors from an external perspective as a single processing resource having a single IP address. What is needed in such situations, therefore, and an object of the present invention, is method and apparatus for handling IP-related applications on different processors all having a same Media access layer (MAC) address (i.e., a same layer 2 address).

### BRIEF SUMMARY OF THE INVENTION

A telecommunications platform has a cluster of processors which collectively perform a platform processing function. Plural processors of the cluster have Internet Protocol (IP) capabilities and respective plural IP interfaces. An Internet Protocol (IP) handler distributed throughout the cluster facilitates applications executing on the plural processors comprising the cluster to be addressed using a same Media access layer (MAC) address. That is, the Internet Protocol (IP) handler comprises a single IP stack which is addressed with the same Media access layer (MAC) address

The Internet Protocol (IP) handler comprises a media access control (MAC) bridge. The MAC bridge in turn comprises a virtual bridge port (first port) connected by an ethernet link interface to the IP stack; a second bridge port provided by a first processor of the cluster; a third bridge port provided by a second processor of the cluster; and, a MAC bridge communications system. The MAC bridge communications system connects the virtual bridge port, the second bridge port, and the third bridge port to each other. The MAC bridge communications system can take various forms, such as (for example) a cluster internal communications path which utilizes, e.g., ATM AAL5 technology.

Each of the second bridge port and the third bridge port have a MAC/port table by which the ports can associate the MAC address of the IP stack with the virtual bridge port, thereby permitting the IP stack to be addressable with one and the same Media access layer (MAC) address which is associated with the virtual bridge port.

The Internet Protocol (IP) handler comprises an active router; a distributed socket; and an interface interconnect. The active router is hosted by at least one of the processors of the cluster, which processor is designated the active central processor. The interface interconnect interconnects the plural IP interfaces to the router and passes IP frames incoming to the platform to the router regardless of which of the plural IP interfaces receives the frames. In an illustrated example embodiment, the interface interconnect comprises an interface interconnect central part hosted by the at least one of the processors of the cluster that hosts the router, and an interface interconnect distributed part hosted by the one of the processors of the cluster that executes the internet protocol (IP) software application. The interface interconnect central part hosts the virtual bridge port and the second bridge port, and the interface interconnect distributed part hosts the third bridge port.

In one embodiment, the second bridge port provided by a first processor of the cluster and the third bridge port provided by a second processor of the cluster are respectively connected to a first local area network (LAN) and a second local area network (LAN). In an alternate embodiment, the second bridge port provided by the first processor of the cluster and the third bridge port provided by the second processor of the cluster are connected to a same local area network (LAN).

As a further advantage, the plural processors of the cluster all have a same IP address. That is, the Internet Protocol (IP) handler renders the IP interfaces of the plural processors of the cluster exchangeable so that knowledge of which one of the plural processors of the cluster is hosting an IP software application being accessed is unnecessary when selecting one of the plural IP interfaces for connecting to the cluster.

The Internet Protocol (IP) handler is capable of handling different types of IP interfaces, such as Ethernet interfaces connected to the main processors of the main processor cluster (MPC) as well as other types of interfaces. An example of such other type of interface is an ATM interface which carries IP packets over an inter-platform link.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view of a telecommunications platform having a main processor cluster with an Internet Protocol (IP) handler according to an embodiment of the invention.

FIG. 1A is a schematic view of the telecommunications platform of FIG. 1, but being connected to a single local area network (LAN) rather than to plural local area networks (LANs).

FIG. 2 is a schematic view showing the Internet Protocol (IP) handler in the context of a switch-based platform.

FIG. 3 is a schematic view of a first example detailed implementation of an Internet Protocol (IP) handler.

FIG. 3A is a schematic view of a second example detailed implementation of an Internet Protocol (IP) handler.

FIG. 4 is a schematic view of a distributed socket central part included in the Internet Protocol (IP) handler of FIG. 3.

FIG. 5 is a diagrammatic view of portions of an Internet Protocol (IP) handler including MAC/port tables at ports of a MAC bridge.

FIG. 6 is a schematic view of one example embodiment of a ATM switch-based telecommunications platform having the Internet Protocol (IP) handler of the invention.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

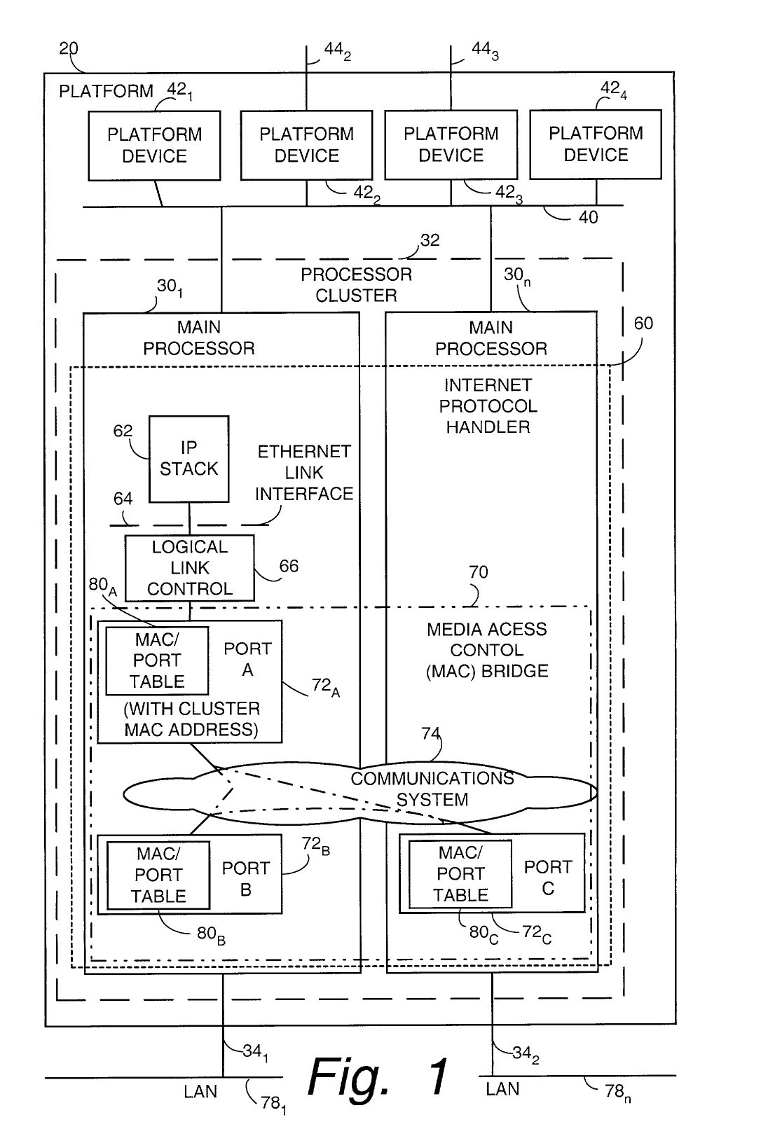

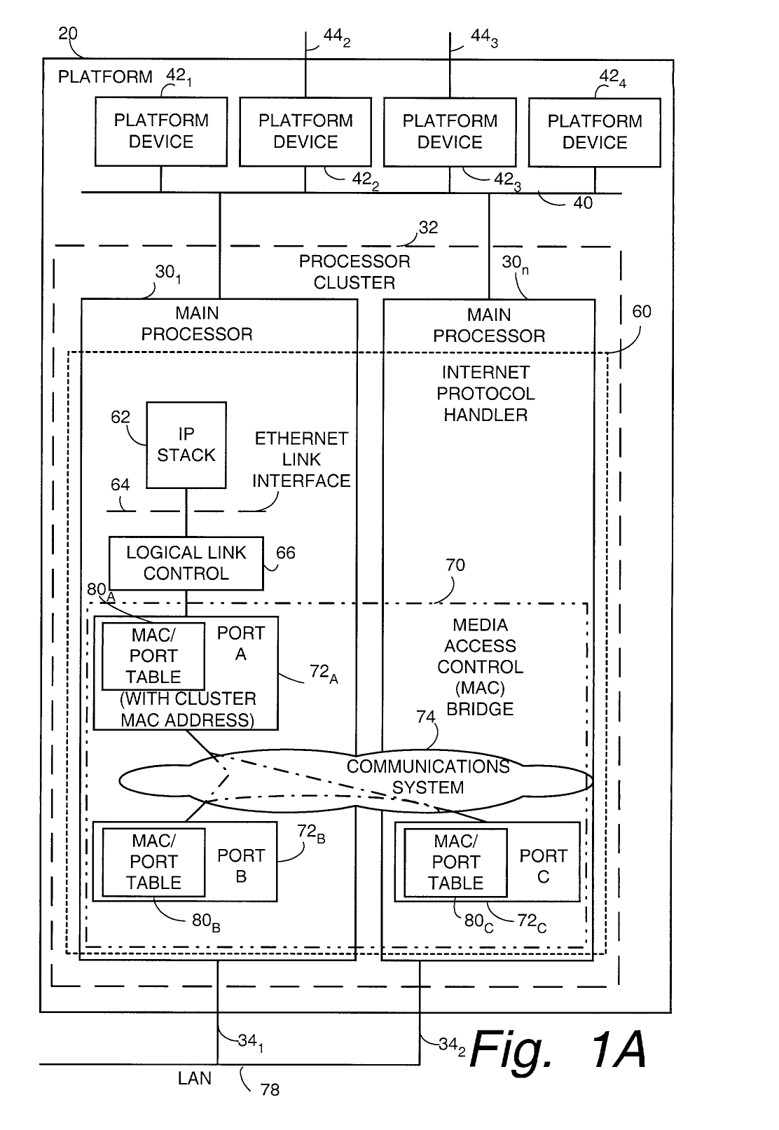

In the prior art, many telecommunications platforms have a single processor which serves as a main processor for the platform. The main processor provides an execution environment for application programs and performs supervisory or control functions for other constituent elements of the platform. In contrast to a single processor platform, FIG. 1 shows a generic multi-processor platform 20 of a telecommunications network, such as a cellular telecommunications network, for example, according to the present invention. The telecommunications platform 20 of the present invention has a main processor function of the platform distributed to plural processors 30, each of which is referenced herein as a main processor or MP. Collectively the plural processors 30 comprise a main processor cluster (MPC) 32 which is framed by a dashed line in FIG. 1. FIG. 1 shows the main processor cluster (MPC) 32 as comprising n number of main processors 30, e.g., main processors 30₁ through 30ₙ.

The main processors 30 comprising main processor cluster (MPC) 32 are connected by an unillustrated inter-processor communication link. Furthermore, one or more of the main processors 30 can have an internet protocol (IP) interface for connecting to data packet networks. In the particular platform 20 of FIG. 1, each of the main processors 30 comprising main processor cluster (MPC) 32 is provided with an IP interface 34. The IP interfaces 34₁-34ₙ illustrated in FIG. 1 happen to be a first type of IP interface, such as an Ethernet interface, for example. Each of the main processors 30 comprising main processor cluster (MPC) 32 is capable of executing one or more IP-related software applications, also known as IP management services. As used herein, an IP-related software application (IP-SW) is any software application which uses an IP transport service, such as the TCP, UDP, or raw IP transport services.

The constituent elements of telecommunications platform 20 communicate with one another using an intra-platform communications system 40. The intra-platform communications system 40 connects to each of the constituent elements of telecommunications platform 20, including to each of the main processors 30 comprising main processor cluster (MPC) 32 as well as to platform devices 42. In the particular example platform shown in FIG. 1, intra-platform communications system 40 can take the form of an ethernet LAN which interconnects platform devices.

FIG. 1 shows j number of platform devices 42 included in telecommunications platform 20. The platform devices 42₁-42ⱼ can, and typically do, have other processors mounted thereon. In some embodiments, the platform devices 42₁-42ⱼ are device boards. Although not shown as such in FIG. 1, some of these device boards have a board processor (BP) mounted thereon for controlling the functions of the device board, as well as special processors (SPs) which perform dedicated tasks germane to the telecomunications functions of the platform.

Some of the platform devices 42 connect externally to telecommunications platform 20, e.g., connect to other platforms or other network elements of the telecommunications system. For example, platform device 42₂ and platform device 42₃ are shown as being connected to inter-platform links 44₂ and 44₃, respectively. The inter-platform links 44₂ and 44₃ can be bidirectional links carrying telecommunications traffic into and away from telecommunications platform 20. The traffic carried on inter-platform links 44₂ and 44₃ can also be internet protocol (IP) traffic which is involved in or utilized by an IP software application(s) executing at one or more main processors 30.

Whereas in the prior art each of the main processors 30 comprising main processor cluster (MPC) 32 and having an IP interface 34 would be accorded a separate IP address, in the telecommunications platform 20 of the present invention there is but one IP address for the entire platform. Moreover, in the present invention, although frames of IP data packets incoming to telecommunications platform 20 from outside may be intended for a IP software application executing on one of the main processors 30 of main processor cluster (MPC) 32, such frames can be received on any of the IP interfaces of the platform (since all IP interfaces have the same address) and will be forwarded appropriately to the correct one of main processors 30 for which the frames are intended.

Further, the present invention facilitates employment of a single media access layer (MAC) address for the entire main processor cluster 32. The functions of the Media Access Control (MAC) layer includes providing physical transport channels, physical layer addressing, and control of the physical layer. The single media access layer (MAC) address is utilized for the entire main processor cluster 32, regardless at which processor 30 an IP service is executed.

The present invention provides an Internet Protocol (IP) handler 60 which (as shown generally in FIG. 1 as being framed by a dotted line) is also distributed over the main processors 30 comprising main processor cluster (MPC) 32. In one of its aspects, the Internet Protocol (IP) handler 60 accomplishes, e.g., single IP-addressing and single MAC-addressing for a platform with a multi-processor cluster. The Internet Protocol (IP) handler 60 comprises an Internet Protocol stack (IP stack 62). The IP stack 62 is a single IP stack which communicates over ethernet link interface 64 with logical link control (LLC) 66.

The logical link control (LLC) 66 is connected to media access control (MAC) bridge 70. The media access control (MAC) bridge 70 is framed in FIG. 1 by a dashed/double-dotted line. The media access control (MAC) bridge 70 comprises a first bridge port which is also known as the virtual bridge port, a second bridge port, and a third bridge port. The first bridge port 72_{A} is also labeled “port A”; the second bridge port 72_{B} is also labeled “port B”; the third bridge port 72_{C} is also labeled “port C”. Both the virtual bridge port 72_{A} and second bridge port 72_{B} are provided by processor 30₁; the third bridge port 72_{C} is provided by another processor, e.g., processor 30ₙ.

The first bridge port 72_{A} has a MAC address for the entire MP cluster 32. The second bridge port 72_{B} and the third bridge port 72_{C} each have separate MAC addresses, but neither of these MAC addresses serve as the MAC address for the MP cluster 32.

The ports of media access control (MAC) bridge 70 are connected by communications system 74. That is, communications system 74 interconnects virtual bridge port 72_{A}, bridge port 72_{B}, and bridge port 72_{C} (as well as any other ports which may be included in media access control (MAC) bridge 70). The MAC bridge communications system can take various forms, such as (for example) a cluster internal communications path which utilizes ATM technology, e.g., ATM Adaptation Layer 5 (AAL5). In other exemplary implementations the communications system 74 can take the form of a X.25 network or a TCP/IP network, for example.

To accommodate the Media Access Control (MAC) layer and usage of a single MAC address for cluster 32, each of the ports of media access control (MAC) bridge 70 (e.g., virtual bridge port 72, bridge port 72_{B}, and bridge port 72_{C}) has a MAC/PORT table 80. For example, as illustrated in FIG. 1, virtual bridge port 72_{A} has MAC/PORT table 80_{A}; bridge port 72_{B} has MAC/PORT table 80_{B}; and bridge port 72_{C} has MAC/PORT table 80_{C}. An advantage of the Internet Protocol (IP) handler 60 of the present invention is that there can be only one MAC address for the entire main processor cluster 32, regardless at which processor 30 an IP service is executed. To cater to employment of the single MAC address, each MAC/PORT table 80 maintains, e.g., a stored association of the MAC address of the main processor cluster 32 with a port of media access control (MAC) bridge 70 which is connected to IP stack 62. In the particular example illustrated in FIG. 1, virtual bridge port 72_{A} is the port of media access control (MAC) bridge 70 which is connected to IP stack 62, so that the MAC/PORT tables 80 associate the MAC address of the main processor cluster 32 with virtual bridge port 72_{A}.

Certain behavior of bridges has been standardized in IEEE standard 802.1D. In an example, representative implementation of the present invention, the media access control (MAC) bridge 70 is categorized as a multiple port, learning bridge. The virtual bridge port 72_{A} and bridge port 72_{B} are provided by processor 30₁, whereas the bridge port 72_{C} is provided by another processor, e.g., processor 30ₙ. Further, the ports of media access control (MAC) bridge 70 are connected together via a communications network (such as communications system 74). The communications network transports data packets between the ports, and the ports exchange topology information via the communications network.

The term “multiple port” implies that more than two LANs can be connected by the media access control (MAC) bridge 70. Such as depicted in the FIG. 1 embodiment, which implies that an arbitrary number n of LANs 78 can be connected to the media access control (MAC) bridge 70. In the FIG. 1A embodiment, on the other hand, all processors 30 of the cluster 32 are connected to one and the same LAN 78.

The “learning” aspect of media access control (MAC) bridge 70 accrues in view of intelligence of the ports to learn by which port of the bridge a specific MAC address can be reached. The ports learn this MAC address-associated port by monitoring the traffic over media access control (MAC) bridge 70. Further, as noted above, the ports exchange topology information, so that the topology of media access control (MAC) bridge 70 becomes known by all ports included in media access control (MAC) bridge 70. In this way the traffic between two MAC addresses on the same LAN can be filtered away by the port connected to that LAN so that such traffic is not passed to the other LANs attached via the other ports. Initially, before a port has learned about where existing MAC addresses are located, a port will send all packets that are received via the LAN connected to the port to all other ports. In order to facilitate modification of the topology during run time, all tables with MAC addresses learnt by the ports will age, so that table entries will be removed after a certain aging time (e.g., about one minute).

Thus, as evidenced from the foregoing, rather than transmit packages on a physical LAN, as one of its aspects example embodiments of the present invention transmits packages virtually by software inside the processor cluster 32 to virtual bridge port 72. The term “Virtual Bridge Port” here means a bridge port that is emulated by software. The Virtual Bridge Port also functions as end-station and provides a MAC service to the logical link control (LLC) 66.

In embodiments which implement a spanning tree technique, media access control (MAC) bridge 70 can detect and close network loops that may occur when more than one bridge (or similar equipment) are interconnected. A spanning tree is an algorithm implemented in the ports (e.g., ports 72) that ensures that all LANs can communicate with each other, and where all loops in the topology are eliminated. Bridge Protocol Data Units (BPDUs) are packets used by media access control (MAC) bridge 70 to detect loops.

The present invention thus integrates a bridge, e.g., media access control (MAC) bridge 70, in main processor cluster 32, having one bridge port 72_{B,} 72_{C} per processor and with a novel virtual bridge port 72_{A}. The virtual bridge port 72_{A} is connected to the logical link control (LLC) 66. The transport medium between the ports (e.g., ports 72_{B}, 72_{C}) is, in the illustrated non-limiting example, inter-process signaling via an ATM switch that interconnects all processors 30.

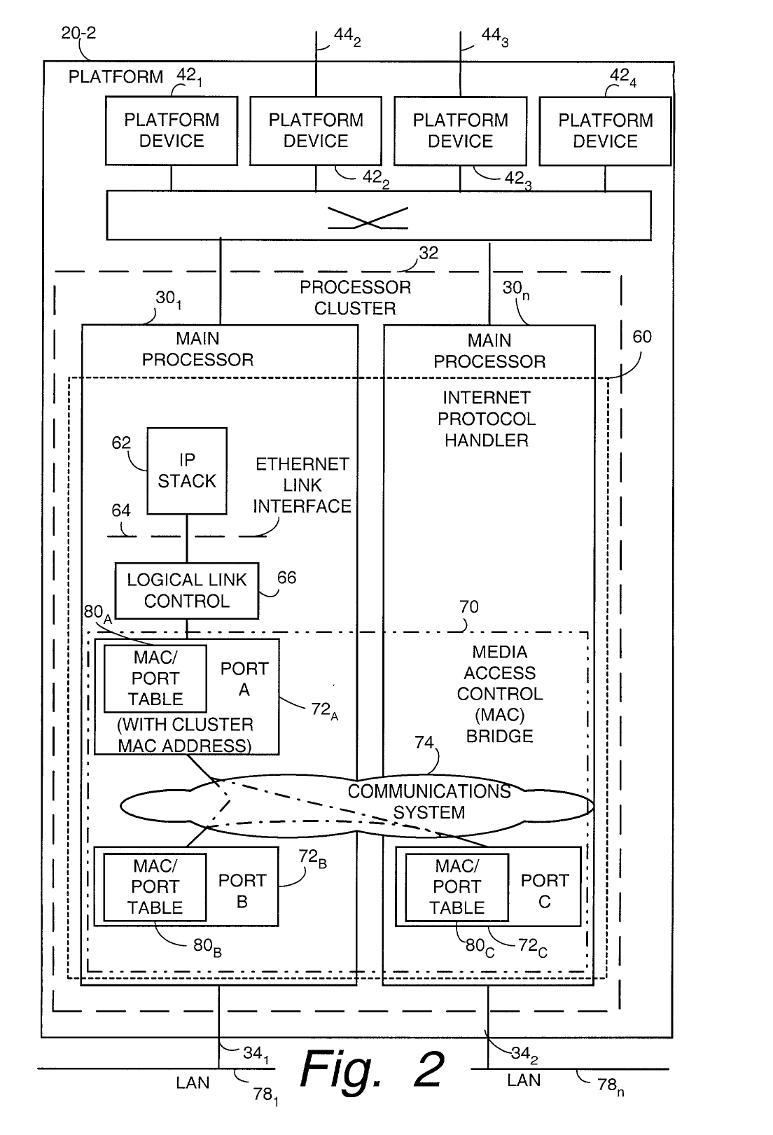

FIG. 2 shows another embodiment of the present invention wherein platform 20-2 is a switch-based platform. The embodiment of FIG. 2 differs from that of FIG. 1 primarily in that intra-platform communications system 40-2 is a switch (e.g., ATM switch) which interconnects platform devices. Thus, it should be understood that the invention is not confined or restricted to any particular implementation of features such as the intra-platform communications system 40.

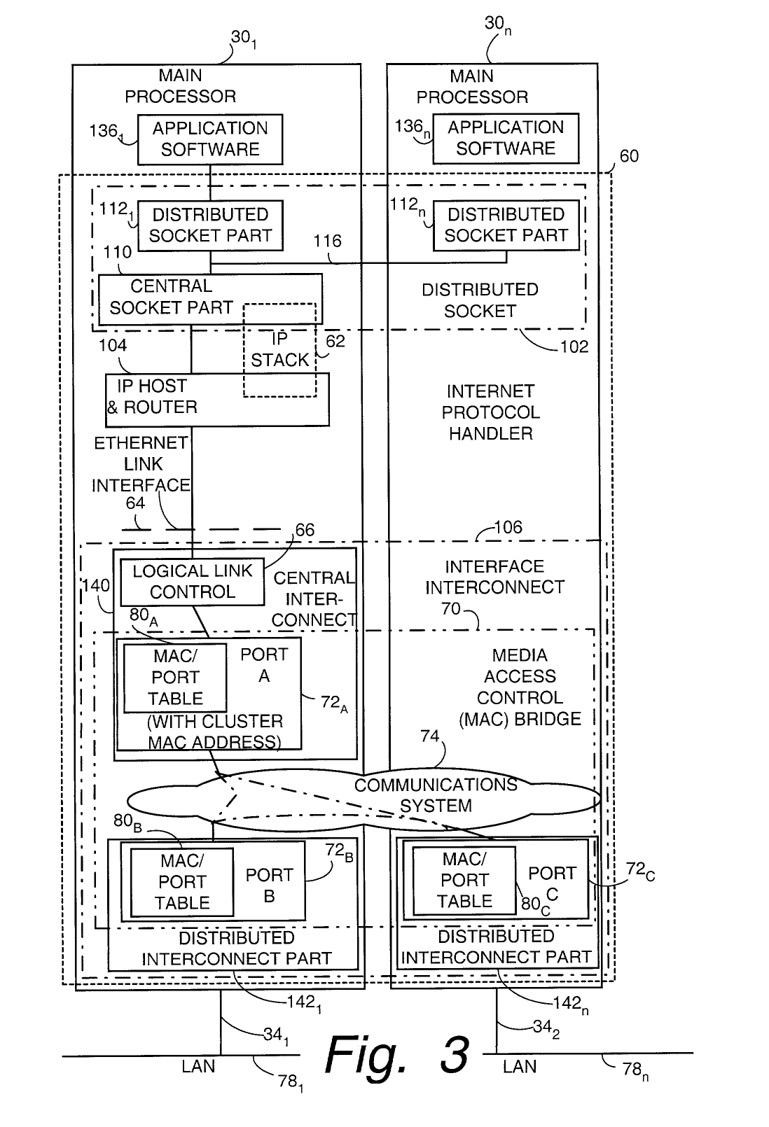

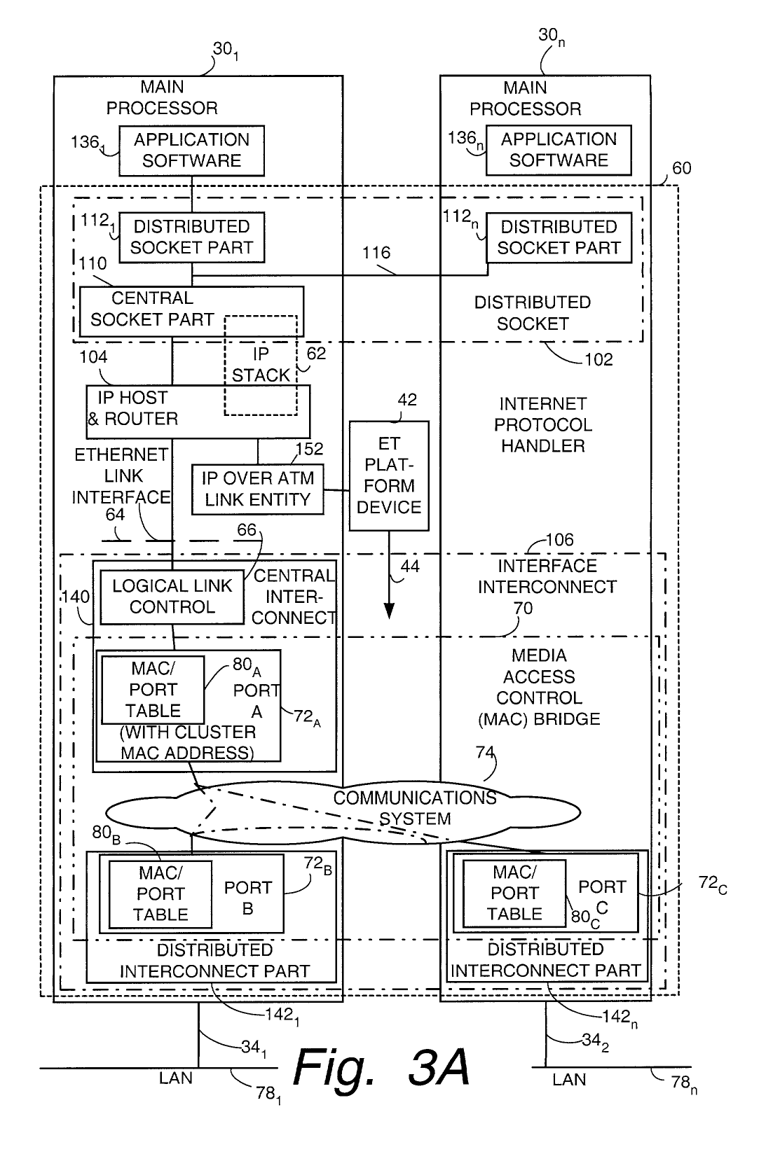

FIG. 3 shows in more detail certain aspects of an example, non-limiting implementation of Internet Protocol (IP) handler 60. The example Internet Protocol (IP) handler 60 comprises distributed socket 102; active IP host and router 104; and interface interconnect 106. As shown in FIG. 3, one of the main processors 30 (i.e., processor 30₂) comprising main processor cluster (MPC) 32 hosts the IP host and router 104, and for that reason is known as the active central processor for Internet Protocol (IP) handler.

The distributed socket 102 of Internet Protocol (IP) handler 60 is framed by a dot-dashed line in FIG. 3. The distributed socket 102 comprises a socket active main or central part 110 which is hosted by the active central processor for Internet Protocol (IP) handler. In addition, distributed socket 102 comprises socket distributed parts 112 which are hosted by all IP-involved main processors 30 comprising main processor cluster (MPC) 32, e.g., socket distributed parts 112₁ and 112ₙ hosted respectively by processors 30₁ and 30ₙ in the FIG. 3 embodiment.

Data transport through distributed socket 102 between socket central part 110 and socket distributed parts 112 is carried by an intra-cluster link 116, e.g., an OSE-Delta link. As such, each of socket central part 110 and socket distributed parts 112 have an unillustrated OSE-Delta link handler. The socket parts 110, 112 connect to the IP-related software application sections for their respective processors. For example, socket distributed part 112₁ hosted by main processor 30₁ is connected to IP-related software application section 136₁ for the running of IP software applications on main processor 30₁. Similarly, socket distributed part 112ₙ hosted by main processor 30ₙ is connected to IP-related software application section 136ₙ for the running of IP software applications on main processor 30ₙ.

The distributed socket 102 enables IP-related application software executed at any of the main processors 30 of the main processor cluster (MPC) 32 to access a single IP-stack 62 of the platform. The single IP-stack 62 of the platform is located in socket central part 110 and IP host and router 104. Together, socket central part 110 and the is socket distributed parts 112 provide the TCP and UDP transport services and access to the raw IP transport service.

The socket distributed parts 112 provide distributed socket interfaces on all IP-utilizing processor 30 in main processor cluster (MPC) 32. In this regard, the socket distributed parts 112 provide TCP/UDP and raw IP sockets with standard primitives. Software applications using the socket services behave in relation to socket distributed parts 112 in the same way as to a normal socket. The invention is equally applicable whether Berkley standard socket or any other standard socket is employed.

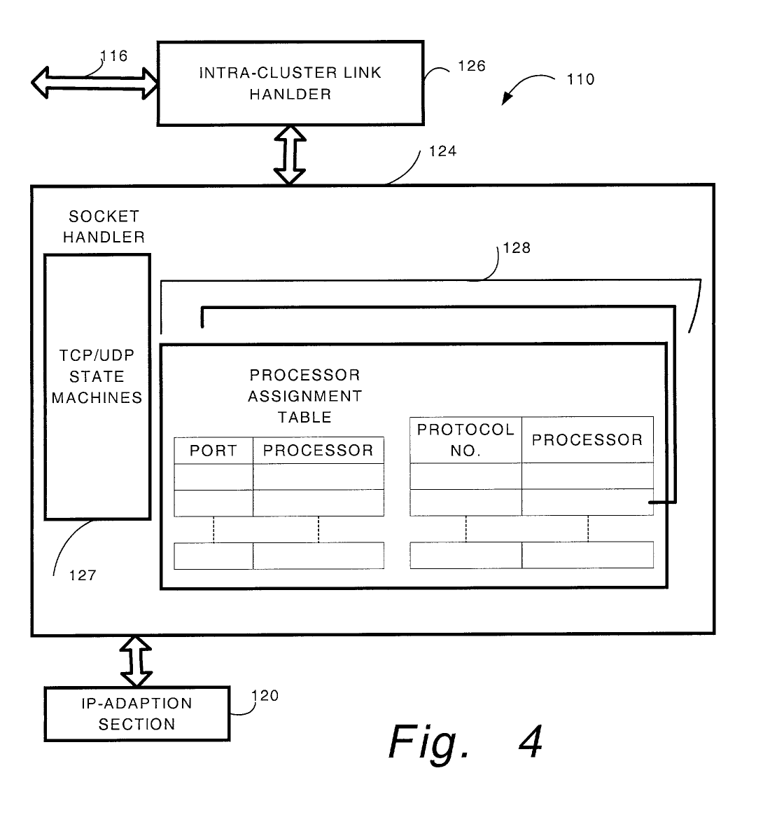

As shown in FIG. 4, the socket central part 110 of the distributed socket comprises, e.g., IP-adaption section 120; a socket handler 124; and intra-cluster link handler 126. The socket handler 124 includes TCP/UDP state machines 127 and a set of processor assignment tables 128. The TCP/UDP state machines 127 utilize information about the states of a particular connection. The set of processor assignment tables 128 includes a table for each link interface that has an IP address assigned to it. The distributed socket makes it possible to use one and the same IP address for all applications that communicate with IP and that are executing in main processor cluster (MPC) 32, even though any of the IP addresses can host a set of distributed sockets.

The set of processor assignment tables 128 contains all used TCP/UDP ports (port identifiers) and their localization (e.g., the identity of the hosting one of the processors 30). For TCP and UDP transport services, each processor assignment table 128 can map the used ports to one of the processors 30, as depicted by the left portion of processor assignment table 128 in FIG. 4. For raw IP transport, the processor assignment table 128 indicates on which processor 30 a raw IP socket for a particular protocol number is located, as depicted by the right portion of processor assignment table 128 in FIG. 4. The socket handler 124 thus supervises all processors that host an active application software (i.e., has a used TCP/UDP port or raw IP socket).

The IP-adaption section 120 performs activities such as, for example, packing TCP segments and UDP datagrams into IP packets.

The intra-cluster link handler 126, which in the illustrated embodiment uses the example of an OSE-Delta link handler, is the general mechanism for communication between processors 30 of main processor cluster (MPC) 32. The intra-cluster link 116 uses this communication mechanism to transport TCP segments, UDP datagrams, and data that is sent using the raw IP service to/from the socket central part 110 and for communication between socket central part 110 and socket distributed parts 112 for, e.g., updating processor assignment table 128.

When one of the IP-utilizing software applications creates a socket and binds the socket to a source port number and a source IP address, the socket distributed part 112 on the processor 30 executing that software application communicates (over intra-cluster link 116) the port number, the IP address, and the processor identity to socket central part 110. Upon receipt of such communication, socket handler 124 updates its processor assignment table 128 (see FIG. 4) so that processor assignment table 128 maps the port number to the processor identity in the case of TCP/UDP transport services, and maps protocol numbers to processors for raw IP sockets.

In view of the fact that, in the illustrated embodiment, the IP interfaces 34 are Ethernet interfaces, the interface interconnect 106 is an Ethernet interconnect mechanism which passes all Ethernet frames, no matter which interface 34 receives them, to the same router port (i.e., IP host and router 104) in one copy. An IP-packet addressed to a host of the local area network [LAN] (e.g., a main processors 30 comprising main processor cluster (MPC) 32) is sent on the LAN in one copy.

As shown in FIG. 3, interface interconnect 106 is famed by a dot-dashed line, and also comprises a central part 140 and distributed parts 142. For example, main processor 30₁ hosts distributed interface interconnect part 142₁ and main processor 30ₙ hosts distributed interface interconnect part 142ₙ. The physical ethernet interface on each processor 30 is connected to the appropriate one of the distributed interface interconnect parts 142. An ethernet LAN may be connected via one or more of the physical ethernet interfaces at the same time, or different hosts or routers may be connected to different physical ethernet interfaces.

The interface interconnect central part 140 connects with each of distributed interface interconnect parts 142 over communications system 74. The communications system 74 provides a general transport mechanism for communication between programs on different microprocessors 30. The bridge ports 72 use communications system 74 for sending IP packets packet into ethernet frames between the central interconnect part 140 and the distributed interconnect parts 142. The logical link control (LLC) 66 packs IP packets into ethernet frames.

The interface interconnect central part 140 can request bridge port 72A to send an Address Resolution Protocol (ARP) request message (e.g., when an IP address needs to be translated to a Media Access Control (MAC) address). This Address Resolution Protocol (ARP) request message is sent via bridge ports 72B and 72C. When an ARP response message is received via 72B or 72C, the MAC port table at one of bridge ports 72B and 72C is updated accordingly depending on over which interface the response was received. This means, that in the present invention, the interface interconnect central part 140 does not deal with learning over which interface a specific MAC address can be reached. This is all solved by the MAC bridge logic.

Describing aspects including the foregoing in more detail, the interface interconnect central part 140 has an Address Resolution Protocol (ARP) cache. If IP host and router 104 requests transmission of an outgoing IP packet, but the destination IP address is not found in the ARP cache, the interface interconnect central part 140 broadcasts an ARP request message on the intra-cluster link to all distributed interface interconnect parts 142. When an ARP response message is received via a particular one of the IP interfaces 34 tied to the distributed interface interconnect parts 142, the MAC port table at one of bridge ports 72B and 72C is updated accordingly depending on over which interface the response was received. The outgoing IP packet is then sent as a unicast message across that particular IP interface 34 via which the ARP response message was received, using the distributed interface interconnect part 142 that received the ARP response message, and using the MAC address received in the ARP response message.

By virtue of provision of Internet Protocol (IP) handler 60, main processor cluster (MPC) 32 appears to an external viewer (as well as for IP application software executing in the main processor cluster (MPC) 32) as one single IP processing resource. The fact that main processor cluster (MPC) 32 actually comprises plural main processors 30 need only be known by main processor cluster (MPC) 32 itself. The Internet Protocol (IP) handler 60 can handle socket interfaces on different main processors 30 all having the same address, and makes the IP interface of the main processor cluster (MPC) 32 exchangeable. That is, one need not know which particular one of the plural main processors 30 of main processor cluster (MPC) 32 is hosting the IP-related application software being accessed when selecting an IP interface to connect to main processor cluster (MPC) 32.

The present invention with its Internet Protocol (IP) handler 60 also facilitates employment of a single MAC address for the main processor cluster (MPC) 32. Similarly to the consolidated IP address aspect described above, one need know only the one MAC address for the main processor cluster (MPC) 32, and need not know which particular processor 30 is hosting the IP-related application software being executed. That is, the plural internet protocol (IP) software applications executed by the plural processors of the cluster have one media access layer (MAC) address, i.e., the MAC address associated with IP stack 62.

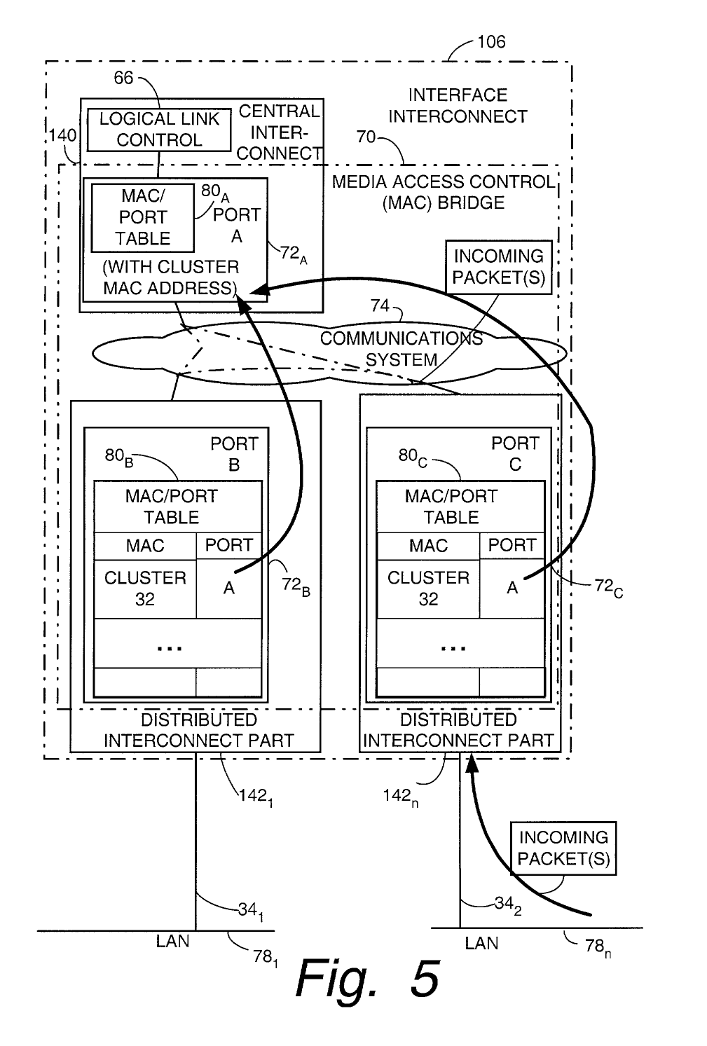

In operation, incoming frames intended for use by an IP service executed at one of the processors 30 of cluster 32 of the platform are received from a LAN at one of the distributed interconnect parts 142. The incoming frames can be received on any of the IP interfaces, such as IP interfaces 34, for example. The incoming frames have a MAC address associated with the cluster 32 of the platform. FIG. 5 shows such frames being received by distributed interconnect part 142ₙ realized by processor 30ₙ. The receiving distributed interconnect part 142 is associated with a port 72_{B}, 72_{C} of the media access control (MAC) bridge 70. By consulting the MAC/PORT table 80 belonging to the port of the receiving distributed interconnect part 142, the receiving port can determine which port of media access control (MAC) bridge 70 is associated with the IP stack 62 of the main processor cluster 32. In the FIG. 5 illustration, for example, port 72_{C} of distributed interconnect part 142ₙ consults its MAC/PORT table 80_{C} and determines that virtual bridge port 72_{A} (also labeled “port A”) is associated or paired with the MAC address which designates IP stack 62 of the cluster 32 (e.g., with MAC address “cluster 32”). The port 72_{C} of distributed interconnect part 142ₙ then routes the incoming frames over communications system 74 to virtual bridge port 72_{A}, so that the incoming frames can be applied to IP stack 62.

With the MAC address associated with IP stack 62 having been resolved in the aforedescribed manner, the active socket central part 110 determines which of the particular plural processors of the cluster is executing the internet protocol (IP) software application to which the incoming frames are destined. The determination is made with reference to processor assignment table 128 (see FIG. 4). The socket central part 110 forwards TCP segments, UDG datagrams or IP frames (in case of that the raw IP transport service is used) to socket distributed parts 112 for the correct processor (e.g., the processor executing the socket bound to the destination IP address and the destination port). The internet protocol (IP) software application receives the IP frames from the socket distributed part.

The IP host and router 104 works in a context of several types of connected links. For example, IP host and router 104 works with links connected to interface interconnect central part 140 and links connected to socket central part 110. Moreover, in another embodiment illustrated in FIG. 3A, distributed socket 102 works with adoptions to other IP interfaces, such as ATM links (RFC1483).

In the above regard, in the FIG. 3 embodiment Internet Protocol (IP) handler 60 provided a same IP address despite the fact that telecommunications platform 20 had plural IP interfaces 34 of a first type. In the foregoing discussion, the example of an Ethernet IP interface was provided as a first type of IP interface. FIG. 3A shows an embodiment of Internet Protocol (IP) handler 60A for a scenario in which the platform includes a second type of IP interface. In particular, in the FIG. 3A embodiment, IP data packets can also be received (for an IP software application executing on one of main processors 30 of main processor cluster (MPC) 32) on another type of IP interface over inter-platform link 44 from outside of telecommunications platform 20. In the illustrated embodiment, the example second type of IP interface is an Asynchronous Transfer Mode (ATM) interface over an ATM bidirectional link such as inter-platform link 44. The invention is equally applicable with interfaces other than ATM as the second type, for example a link based on the Point to Point Protocol (PPP).

In the FIG. 3A embodiment, the ATM cells constituting the IP frames are received at extension platform device 42, and are forwarded over link 150 (RFC1483) to IP over ATM link entity 152. The IP over ATM link entity 152 resides on the same processor that hosts the active IP host and router 104, and is connected to IP host and router 104 as shown in FIG. 3A.

The IP over ATM link entity 152 comprises an endpoint for an outgoing ATM connection and functionality for mapping IP packets to the ATM (AAL5) connection according to RFC 1483. Although for sake of simplicity only one IP over ATM link is shown attached to IP host and router 104 in FIG. 3A it should be understood that more than one IP over ATM link can be provided, e.g., in a situation in which IP host and router 104 is connected to other hosts/routers.

The provision of this second type of IP interface makes it possible to reach any IP software application using ATM transport, regardless of which of the main processors 30 in main processor cluster (MPC) 32 is hosting or executing the IP software application.

Thus, in the example platform of FIG. 3A, it is possible to have internet protocol communications over both (1) the Ethernet interfaces 34 of the plural processors comprising the MPC; and (2) the external links (e.g., the ATM links 44 connected to the ETs). Moreover, an objective of the example platform is to have one IP address for all applications executed by the processors of the MPC, despite the numerous IP interfaces owned by the platform. In other words, the platform has one IP address for all applications, e.g., HTTP, Telnet, Corba, SNMP, FTP, etc.

The main processor cluster (MPC) 32 has a cluster support function which is distributed over the main processors 30 comprising main processor cluster (MPC) 32. The cluster support function makes the main processor cluster (MPC) 32 robust against hardware faults in the main processors 30 and against software executing on main processors 30. Moreover, the cluster support function facilitates upgrading of application software during run time with little disturbance, as well as changing processing capacity during run time by adding or removing main processors 30 of main processor cluster (MPC) 32.

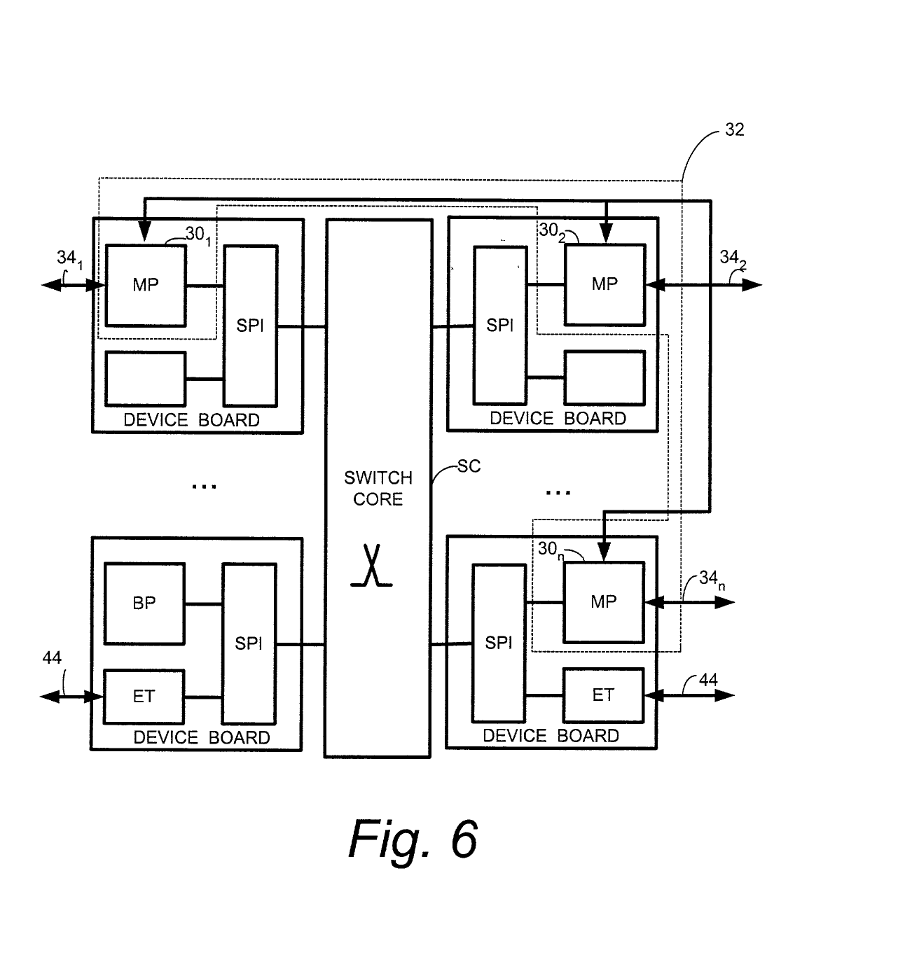

FIG. 6 shows one example embodiment of a ATM switch-based telecommunications platform having the Internet Protocol (IP) handler 60 of the invention. In the embodiment of FIG. 6, each of the main processors 30 comprising main processor cluster (MPC) 32 are situated on a board known as a device board. The main processor cluster (MPC) 32 is shown framed by a broken line in FIG. 6. The main processors 30 of main processor cluster (MPC) 32 are connected through a switch port interface (SPI) to a switch fabric or switch core SC of the platform (such as switch 40-2 shown in FIG. 2). Devices on the device boards of the platform communicate via the switch core SC. In addition to the switch port interface (SPI), each device board can have plural devices mounted thereon. In the illustrated embodiment there being as many as four devices situated on a device board (only two devices are shown on each board). In fact, some of the device boards are known as extension terminals (ETs) in view of the fact that devices thereon handle links which connect external to the platform, e.g., interfacing ATM links 44. In general, each of the devices on the device board connect through the switch port interface to the switch core SC.

Whereas the platform of FIG. 6 is a single stage platform, it will be appreciated by those skilled in the art that the Internet Protocol (IP) handler of the present invention can be implemented in a main processor cluster (MPC) realized in multi-staged platforms. Such multi-stage platforms can have, for example, plural switch cores (one for each stage) appropriately connected via extension terminals (ETs) or the like. The main processors 30 of the main processor cluster (MPC) 32 can be distributed throughout the various stages of the platform, with the same or differing amount of processors (or none) at the various stages.

Various aspects of ATM-based telecommunications are explained in the following: U.S. patent applications Ser. No. 09/188,101 [PCT/SE98/02325] and Ser. No. 09/188,265 [PCT/SE98/02326] entitled “Asynchronous Transfer Mode Switch”; U.S. patent application Ser. No. 09/188,102 [PCT/SE98/02249] entitled “Asynchronous Transfer Mode System”, all of which are incorporated herein by reference.

Moreover, the invention can be utilized with single or multiple stage platforms. Aspects of multi-staged platforms are described in U.S. patent application Ser. No. 09/249,785 entitled “Establishing Internal Control Paths in ATM Node” and U.S. patent application Ser. No. 09/213,897 for “Internal Routing Through Multi-Staged ATM Node,” both of which are incorporated herein by reference.

The present invention applies to telecommunications platforms of diverse types, including (for example) base station nodes and base station controller nodes (radio network controller [RNC] nodes) of a cellular telecommunications system. Example structures showing telecommunication-related elements of such nodes are provided, e.g., in U.S. patent application Ser. No. 09/035,821 [PCT/SE99/00304] for “Telecommunications Inter-Exchange Measurement Transfer,” which is incorporated herein by reference.

Externally, the main processor cluster (MPC) 32 of the present invention is viewed as a single processor. The main processor cluster (MPC) 32 has one IP-address that addresses all management services of main processor cluster (MPC) 32 no matter which processor currently hosts the different services. Moreover, the main processor cluster (MPC) 32 has only one layer-two media access layer (MAC) address that addresses the IP stack 62 from all LAN segments.

Further, each individual ethernet interface is useful when connecting external LANs to the platform. An individual ethernet interface may be connected to the same physical LAN or to different LANs. Interfaces can be connected without restrictions to external hubs, bridges, and switches.

The present invention facilitates connection of a main processor cluster (MPC) 32 to a LAN via a LAN interface on any processor board of main processor cluster (MPC) 32, and obtaining the same communication capability independently of what processor board is so utilized. Moreover, it is possible to connect several LAN interfaces in main processor cluster (MPC) 32 to the same LAN (as in the FIG. 1A embodiment) to obtain a more reliable connection. Since transmitted information normally is not allowed to be sent more than one time on the LAN, intelligence is provided to chose one interface in this situation.

The present invention also permits free reconfiguration of a LAN without disturbance of the inventive functionality. For example, when as a result of a fault situation the IP stack is reconfigured to another processor 30 of the main processor cluster (MPC) 32, the same MAC address and IP address as previously used for main processor cluster (MPC) 32 can continue to be used, such a reconfiguration therefore being essentially invisible external to main processor cluster (MPC) 32.

The need of external hardware for interconnecting LAN segments is eliminated by the present invention. Communication between LAN segments is also facilitated.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. For example, while the intra-cluster link handler 126 has been illustrated as being an OSE-Delta link handler, other types of link handlers can instead be utilized. Moreover, the second type of IP interface need not be limited to an ATM interface, but can be some other type of transport instead.

What is claimed is:

1. A telecommunications platform comprising:
a cluster of processors which collectively perform a platform processing function, plural processors of the cluster having Internet Protocol (IP) capabilities and respective plural IP interfaces;
an Internet Protocol (IP) handler distributed throughout the cluster which facilitates applications executing on the plural processors comprising the cluster to be addressed using a same media access layer (MAC) address.

2. The apparatus of claim 1, wherein the Internet Protocol (IP) handler comprises a single IP stack which is addressed with the same media access layer (MAC) address.

3. The apparatus of claim 1, wherein the platform comprises an IP stack, wherein the Internet Protocol (IP) handler comprises a media access control (MAC) bridge; and wherein the MAC bridge comprises:
a first bridge port connected by an ethernet link interface to the IP stack;
a second bridge port provided by a first processor of the cluster;
a third bridge port provided by a second processor of the cluster;
a MAC bridge communications system connecting the first bridge port, the second bridge port, and the third bridge port to each other.

4. The apparatus of claim 3, wherein the MAC bridge communications system is one of a X.25 network, a TCP/IP network, and a cluster internal communications path which uses an Asynchronous Mode Transfer (ATM) technology.

5. The apparatus of claim 3, wherein each of the second bridge port and the third bridge port have a MAC/port table by which the ports can associate the MAC address of the IP stack with the first bridge port.

6. The apparatus of claim 5, wherein the Internet Protocol (IP) handler comprises:
a router hosted by at least one of the processors of the cluster;
an interface interconnect which interconnects the plural IP interfaces to the router and passes IP frames incoming to the platform to the router regardless of which of the plural IP interfaces receives the frames; and
a socket.

7. The apparatus of claim 6, wherein the interface interconnect comprises:
an interface interconnect central part hosted by the at least one of the processors of the cluster that hosts the router; and
an interface interconnect distributed part hosted by the one of the processors of the cluster that executes the internet protocol (IP) software application.

8. The apparatus of claim 7, wherein the interface interconnect central part hosts the first bridge port and the second bridge port, and the interface interconnect distributed part hosts the third bridge port.

9. The apparatus of claim 3, wherein the second bridge port provided by a first processor of the cluster and the third bridge port provided by a second processor of the cluster are respectively connected to a first local area network (LAN) and a second local area network (LAN).

10. The apparatus of claim 3, wherein the second bridge port provided by a first processor of the cluster and the third bridge port provided by a second processor of the cluster are connected to a same local area network (LAN).

11. The apparatus of claim 1, whereby the plural processors have a same IP address, the Internet Protocol (IP) handler forwarding IP frames received from outside the platform on any of the plural IP interfaces and addressed to the same IP address to a correct one of the plural processors executing an IP software application.

12. A method of operating a telecommunications platform, the method comprising:
using a cluster of processors to perform collectively a platform processing function;
providing plural processors of the cluster with Internet Protocol (IP) capabilities and respective plural IP interfaces;
using a same media access layer (MAC) address to address applications executing on the plural processors comprising the cluster.

13. The method of claim 12, wherein the Internet Protocol (IP) handler comprises a single IP stack, and further comprising addressing the single stack with the same media access layer (MAC) address.

14. The method of claim 12, wherein the platform comprises an IP stack, wherein the Internet Protocol (IP) handler comprises a media access control (MAC) bridge; wherein the MAC bridge comprises a first bridge port connected by an ethernet link interface to the IP stack; a second bridge port provided by a first processor of the cluster; a third bridge port provided by a second processor of the cluster; and a MAC bridge communications system connecting the first bridge port, the second bridge port, and the third bridge port to each other; and wherein the method comprises forwarding, over the LAN bridge communications system to the first bridge port, IP frames received from outside the platform at the second bridge port and the third bridge port.

15. The method of claim 14, wherein the MAC bridge communications system 74 is one of a X.25 network, a TCP/IP network, and a cluster internal communications path which uses an Asynchronous Mode Transfer (ATM) technology.

16. The method of claim 14, further comprising using a MAC/port table at each of the second bridge port and the third bridge port to associate the MAC address of the IP stack with the first bridge port.

17. The method of claim 12, further comprising:
using a same IP address for each of the plural processors of the cluster;
forwarding IP frames received from outside the platform on any of the plural IP interfaces and addressed to the same IP address to a correct one of the plural processors executing an IP software application.
